(19) United States
(12) Patent Application Publication
(10) Pub. No.: US 2022/0112128 A1
(43) Pub. Date: Apr. 14, 2022

(54) CEMENT MORTAR COMPOSITION REINFORCED WITH SHREDDED WASTE FISHING NET AND METHOD OF MANUFACTURING SAME

(71) Applicant: KOREA INSTITUTE OF OCEAN SCIENCE & TECHNOLOGY, Busan (KR)

(72) Inventors: Seoung Ik CHOI, Busan (KR); Min Ook KIM, Busan (KR); Taek Hee HAN, Busan (KR); Jun Kil PARK, Busan (KR); Hye Min HONG, Busan (KR); Sung Won KIM, Busan (KR); Sang Min PARK, Busan (KR)

(21) Appl. No.: 17/467,028

(22) Filed: Sep. 3, 2021

(30) Foreign Application Priority Data
Oct. 12, 2020 (KR) 10-2020-0131210

(51) Int. Cl. C04B 18/20; D02G 3/44

(52) U.S. Cl. CPC C04B 18/20; D10B 2505/02; D10B 2401/063; D02G 3/447

(57) ABSTRACT

This application relates to a cement mortar composition reinforced with a shredded waste fishing net and a method of manufacturing the cement mortar composition. In one aspect, the cement mortar composition includes cement mortar including cement, fine aggregate, and water and 0.5 to 2.0 parts by weight of a fibrous reinforcing material based on 100 parts by weight of the cement mortar. The fibrous reinforcing material may be manufactured by shredding a knotless fishing net and being formed of a single yarn that has a length of 3 mm to 60 mm and a diameter of 0.1 mm to 1 mm. The cement mortar composition that has improved crack resistance and tensile strength and in which an environmentally friendly and inexpensive reinforcing material obtained by shredding a waste fishing net at a random length instead of existing highly-expensive reinforcing material is included may be realized.

### CROSS REFERENCE TO RELATED APPLICATION

The present application claims priority to Korean Patent Application No. 10-2020-0131210, filed on Oct. 12, 2020, the entire contents of which is incorporated herein for all purposes by this reference.

### BACKGROUND

### Technical Field

The present disclosure relates to a cement mortar composition using a waste material as a reinforcing material, and relates to a method of manufacturing the cement mortar composition.

### Description of the Related Technology

Cement mortar has excellent performance in compressive strength, but has insufficient performance in crack resistance and tensile strength compared to the compressive strength.

In order to improve both crack resistance and tensile strength of the cement mortar, a fibrous reinforcing material formed of such as steel, carbon, glass, and so on is mixed into the cement mortar, but there is a disadvantage in that a cost of such a fibrous reinforcing material is expensive.

Therefore, there is a need of developing a new cement mortar composition using a fibrous reinforcing material derived from a waste material, the new cement mortar composition being capable of improving mechanical properties of a mortar and being capable of realizing excellent economic efficiency.

### SUMMARY

Accordingly, the present disclosure has been made keeping in mind the above problems occurring in the related art, and an objective of the present disclosure is to provide a cement mortar composition reinforced with a shredded waste fishing net, the cement mortar composition having improved crack resistance and tensile strength and being environmentally friendly since a waste fishing net among ocean trash that has increased recently is included as a reinforcing material, and to provide a method of manufacturing the cement mortar composition that is economically efficiently manufactured by a simple process.

In order to achieve the above objective, according to one aspect of the present disclosure, there is provided a cement mortar composition reinforced with a shredded waste fishing net, the cement mortar composition including: a cement mortar including cement, fine aggregate, and water; and 0.5 to 2.0 parts by weight of a fibrous reinforcing material based on 100 parts by weight of the cement mortar, the fibrous reinforcing material being manufactured by shredding a knotless fishing net and being formed of a single yarn that has a length of 3 mm to 60 mm and a diameter of 0.1 mm to 1 mm.

In addition, the fibrous reinforcing material may include at least one of polyethylene (PE), polypropylene (PP), polyethylene terephthalate (PET), polyvinyl chloride (PVC), polystyrene (PS), and a polyamide-based (PA) polymer.

In addition, according to another aspect of the present disclosure, there is provided a method of manufacturing a cement mortar composition reinforced with a shredded waste fishing net, the method including: (a) collecting a waste knotless fishing net and washing off impurities on the waste knotless fishing net; (b) drying the washed waste knotless fishing net; (c) manufacturing a fibrous reinforcing material formed of a single yarn having a length of 3 mm to 60 mm and a diameter of 0.1 mm to 1 mm by shredding the dried waste knotless fishing net; (d) dry-mixing cement, fine aggregate, and an admixture; (e) mixing by adding water into a dry mixture that is obtained from the dry-mixing (d); (f) mixing by adding the fibrous reinforcing material into a cement mortar that is obtained from the mixing (e); and (g) manufacturing a cement mortar composition by further adding the fibrous reinforcing material into the cement mortar that is obtained from the mixing (f) and includes the fibrous reinforcing material so that the cement mortar composition including 0.5 to 2.0 parts by weight of the fibrous reinforcing material based on 100 parts by weight of the cement mortar is manufactured.

In addition, the cement, the fine aggregate, the admixture may be mixed at a speed of 57 rpm to 67 rpm at the process (d).

In addition, water may be added into the dry mixture obtained at the process (d), and water and the dry mixture may be mixed at a speed of 57 rpm to 67 rpm.

In addition, at the process (f), 50% of a total amount of the fibrous reinforcing material used to manufacture the cement mortar composition reinforced with the shredded waste fishing net may be added and mixed at a speed of 57 rpm to 67 rpm.

In addition, at the process (g), remaining 50% of a total amount of the fibrous reinforcing material used to manufacture the cement mortar composition reinforced with the shredded waste fishing net may be added and stirred at a speed of 57 rpm to 67 rpm, and mixing at a speed of 115 rpm to 135 rpm may be performed so as to allow the added fibrous reinforcing material to be evenly mixed when adding of the fibrous reinforcing material is completed, thereby manufacturing the cement mortar composition reinforced with the shredded waste fishing net.

According to the cement mortar composition reinforced with the shredded waste fishing net of the present disclosure, the cement mortar composition that has improved crack resistance and tensile strength and in which an environmentally friendly and inexpensive reinforcing material obtained by shredding a waste fishing net at a random length instead of existing highly-expensive reinforcing material is included may be realized.

In particular, according to the cement mortar composition reinforced with the shredded waste fishing net of the present disclosure, by including a fibrous reinforcing material formed of a single yarn obtained by shredding a waste knotless fishing net, there is an advantage in that a problem of lowered reinforcing performance due to a knot and a loosening phenomenon of a reinforcing material may be prevented, in which the reinforcing material using the single yarn obtained by shredding the waste knotless fishing net provides advantage different from the reinforcing material using a waste fishing net formed of a plied yarn and including a knot.

In addition, a fiber shredded to have a relatively short length among the fibrous reinforcing material controls cracking of the cement mortar composition, and a fiber shredded to have a relatively long length among the fibrous reinforcing material functions to improve tensile strength and flexural toughness of the cement mortar composition.

### BRIEF DESCRIPTION OF THE DRAWINGS

The above and other objectives, features, and other advantages of the present disclosure will be more clearly understood from the following detailed description when taken in conjunction with the accompanying drawings.

FIG. 1 is a flowchart sequentially illustrating a process that is a method of manufacturing a cement mortar composition reinforced with a shredded waste fishing net according to the present disclosure.

FIG. 2 is a photograph showing an embodiment of a shredded waste fishing net that is included in the cement mortar composition reinforced with the shredded waste fishing net according to the present disclosure.

FIG. 3 is a view illustrating a configuration of a waste fishing net shredder used at a process (c) of shredding a knotless waste fishing net, the process (c) being performed in the method of manufacturing the cement mortar composition reinforced with the shredded waste fishing net.

FIG. 4 is a view illustrating a configuration of a shredding portion of the waste fishing net shredder used at the process (c) of shredding the knotless waste fishing net, the process being performed in the method of manufacturing the cement mortar composition reinforced with the shredded waste fishing net.

FIG. 5 is a partially enlarged view illustrating a configuration of a blade of the waste fishing net shredder used at the process (c) of shredding the knotless waste fishing net, the process being performed in the method of manufacturing the cement mortar composition reinforced with the shredded waste fishing net.

### DETAILED DESCRIPTION

In the following description of the present disclosure, when detailed description of a known function or configuration in the related art makes the gist of the present disclosure unnecessarily obscure, the detailed description thereof will be omitted.

An embodiment according to a concept of the present disclosure can be variously modified and can have various modified examples, and thus specific embodiments are to be illustrated in the drawings and are to be described in detail in this specification. However, an embodiment according to a concept of the present disclosure is not to be limited to a specific disclosed example, and the present disclosure is construed to include every modification, equivalent, and alternative which is included in the idea and the technical scope of the present disclosure.

Terms used in this specification are only used to describe a specific embodiment and are not intentionally used to limit the present disclosure thereto. A singular form of a word includes a plural form thereof, unless obviously implied otherwise in context. In this specification, words such as “to include” or “to have” are construed to specify that a feature, a number, a step, an operation, a configurational element, a part, or an assembly thereof provided therein is present and not to exclude presence or a possibility of addition of one or more other features, numbers, steps, operations, configurational elements, parts, or assemblies thereof in advance.

Hereinafter, the present disclosure will be described in more detail.

In the present disclosure, there is provided a cement mortar composition reinforced with a shredded waste fishing net, the cement mortar composition having improved crack resistance and tensile strength and being environmentally friendly since a waste fishing net among ocean trash that recently has increased is included as a reinforcing material, and there is provided a method of manufacturing the cement mortar composition that is economically efficiently manufactured by a simple process.

Specifically, according to the present disclosure, the cement mortar composition reinforced with the shredded fishing net includes: a cement mortar including cement, fine aggregate, and water; and 0.5 to 2.0 parts by weight of a fibrous reinforcing material based on 100 parts by weight of the cement mortar, the fibrous reinforcing material being manufactured by shredding a knotless fishing net and being formed of a single yarn that has a length of 3 mm to 60 mm and a diameter of 0.1 mm to 1 mm.

In particular, the cement mortar composition according to the present disclosure includes a fiber as a reinforcing material, in which the fiber has a predetermined size without having a knot and is formed of a single yarn obtained by randomly shredding a waste knotless fishing net.

Generally, a fishing net is formed of a yarn such as a cotton yarn, a hemp yarn, a silk yarn, a synthetic yarn, and so on, and is referred to as a netting used in the fishing industry. Further, according to a method of manufacturing a fishing net, the fishing net is divided into a flat knot net, an English knot net, a knotless net, a twisted net, a knitted net. Among the fishing net, the knotless fishing net is formed by a knotless webbing that is woven without tying a knot, so that the knotless fishing net has advantages of being lightweight and good at webbing.

For reference, as a knotless webbing, there is woven webbing, screwing webbing, adhesion webbing, and so on. The woven webbing is knitted by alternately intersecting a weft yarn and a warp yarn as a mosquito net, and is not commonly used in an ordinary fishing net since a mesh of a net is easily twisted. The screwing webbing is knitted by screwing a strand of weft yarn and a strand of warp yarn and binding at a predetermined interval so as to form a mesh of a net to have a rectangular shape, and is widely used for catching a small fish such as an anchovy. Penetration-type webbing was invented to reduce a resistance of a mesh of a net in a dragnet or a trawlnet, and is knitted by braiding a yarn at a predetermined interval so as to be interlocked to each other. In addition, a Raschel webbing, which was invented in Germany, is not performed by weaving a net in a manner of twisting a yarn but performed by weaving a net in a manner of knitting with a yarn having a predetermined thickness. Adhesion webbing is a weaving performed by adhering a yarn to a spot that is the subject of a knot when a net is weaved with a single yarn, and is widely applied to a gill net that is formed of a single yarn.

The fibrous reinforcing material obtained by shredding the waste knotless fishing net has a length of 3 mm to 60 mm. Among the fibrous reinforcing materials, a fiber shredded to have a relatively short length functions to control cracking of the cement mortar composition, and a fiber shredded to have a relatively long length functions to improve tensile strength and flexural toughness of the cement mortar composition.

In addition, the fibrous reinforcing material obtained by shredding the waste knotless fishing net may include at least one of polyethylene (PE), polypropylene (PP), polyethylene terephthalate (PET), polyvinyl chloride (PVC), polystyrene (PS), and a polyamide-based (PA) polymer.

The fibrous reinforcing material obtained by shredding the waste knotless fishing net is included in the cement mortar composition in an amount of 0.5 to 2.0 parts by weight based on 100 parts by weight of the cement mortar. This is because a strength enhancement effect is inadequate when less than 0.5 parts by weight of the fibrous reinforcing material is included, and a problem in that a strength is rather reduced occurs due to reduced porosity and reduced dispersion when more than 2.0 parts by weight of the fibrous reinforcing material is included.

Meanwhile, the cement mortar may include: 5 wt % to 55 wt % of cement; 10 wt % to 75 wt % of fine aggregate; and 1 wt % to 30 wt % of water. As necessary, the cement mortar may further include 1 wt % to 25 wt % of at least one admixture or additive selected from the group consisting of fly ash, diatomaceous earth, volcanic ash, silicate clay, blast-furnace slag fine powder, a water reducing agent, a thickening agent, an air-entraining agent, a waterproofing agent, an expanding agent, a blowing agent, and an anti-foaming agent.

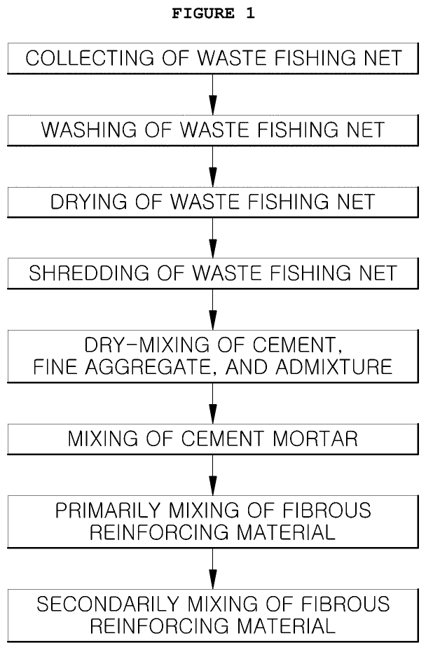

According to the present disclosure, the method of manufacturing the cement mortar composition reinforced with the shredded waste fishing net may include: (a) collecting a waste knotless fishing net and washing off impurities on the waste knotless fishing net; (b) drying the washed waste knotless fishing net; (c) manufacturing a fibrous reinforcing material formed of a single yarn having a length of 3 mm to 60 mm and a diameter of 0.1 mm to 1 mm by shredding the dried waste knotless fishing net; (d) dry-mixing cement, fine aggregate, and an admixture; (e) mixing by adding water into a dry mixture that is obtained from the dry-mixing (d); (f) mixing by adding the fibrous reinforcing material into a cement mortar that is obtained from the mixing (e); and (g) manufacturing the cement mortar composition by further adding the fibrous reinforcing material into the cement mortar in which the fibrous reinforcing material is included that is obtained from the mixing (f) so that the cement mortar composition including 0.5 to 2.0 parts by weight of the fibrous reinforcing material based on 100 parts by weight of the cement mortar is manufactured (see FIG. 1).

In the collecting of the waste knotless fishing net (a), in order not to affect uniformity and quality of the cement mortar composition described later in the mixing of the cement mortar with the fibrous reinforcing material, the impurities such as salt, sand, shells, etc., included in the waste knotless fishing net are washed off.

In the drying of the waste knotless fishing net (b), a drying process is performed so as to remove water contained in the washed waste knotless fishing net in order not to affect uniformity and quality of the cement mortar composition described later in the mixing of the cement mortar with the fibrous reinforcing material.

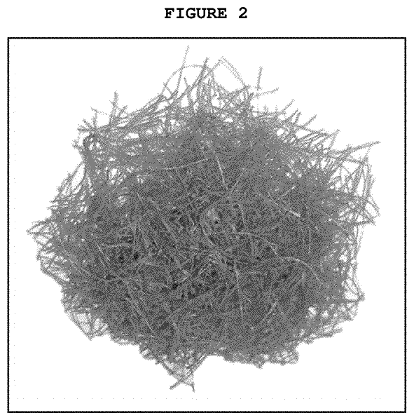

Next, in the manufacturing of the fibrous reinforcing material (c), the fibrous reinforcing material as an embodiment illustrated in FIG. 2 is manufactured by shredding the waste knotless fishing net to have a length of 3 mm to 60 mm and a diameter of 0.1 mm to 1 mm.

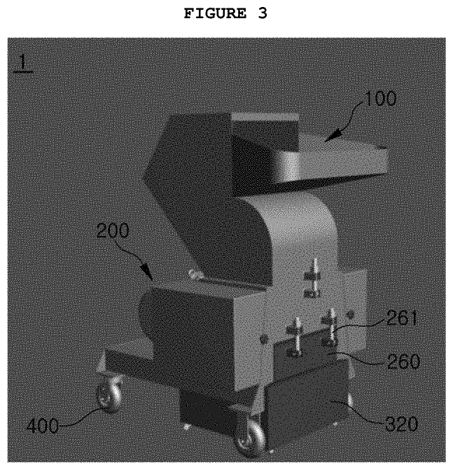

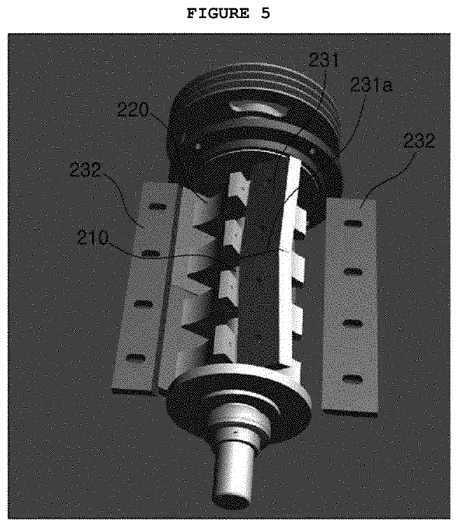

As a detailed method of shredding a waste fishing net in the manufacturing of the fibrous reinforcing material (c), there is no limitation in a shredding method capable of being used by those skilled in the art with considering a type and a use of a cement mortar composition that is finally obtained, but it is preferable that an efficient shredding process may be performed by using a waste fishing net shredder that is illustrated in FIGS. 3 to 5 so as to obtain a desired predetermined size of the fibrous reinforcing material.

Referring to FIG. 3, a waste fishing net shredder 1 used at the process (c) may include a hopper 100, a shredding portion 200, a collecting portion (not illustrated), and a moving member 400.

The hopper 100 is provided at an upper portion of the waste fishing net shredder 1 and configured to allow a waste fishing net to be introduced into the shredding portion 200, and the hopper 100 has a polygonal shape having both an upper end and a lower end opened and the opened lower end thereof is configured to be capable of communicating with the shredding portion 200.

As illustrated in drawings, the hopper 100 may be preferable to have a perimeter of the upper end thereof longer than a perimeter of the lower end thereof.

In addition, while it is preferable that the hopper 100 is formed of a material having a low frictional force so as to allow the waste fishing net to be easily slid down, but the material of the hopper 100 is not limited to a specified material, and known materials may be used without having a limitation.

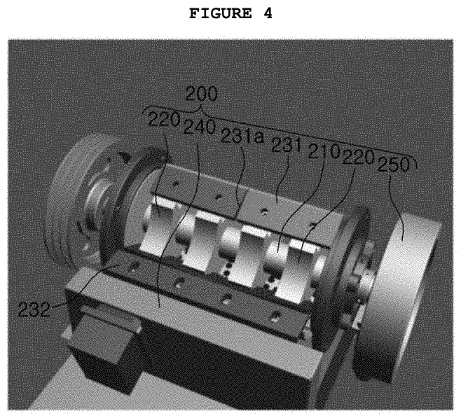

FIG. 4 is a view illustrating a configuration of the shredding portion 200 of the waste fishing net shredder 1, and the shredding portion 200 is constituted such that an upper side thereof communicates with the hopper 100 and a lower side thereof communicates with the collecting portion, so that the waste fishing net introduced into the hopper 100 may be cut or shredded and the waste fishing net which has been shredded may be allowed to be transferred to the collecting portion.

Therefore, the shredding portion 200 may include a rotary shaft 210, a disk 220, a blade 230, a support base 240, a confirmation window 260, and a rotary motor (not illustrated).

The rotary shaft 210 is a shaft extending along a longitudinal direction thereof to which the disk 220 and rotary blade 231 that will be described later are fixed, and has a first side electrically connected with the rotary motor and is configured to be rotated by a driving force supplied from the rotary motor.

In addition, the rotary shaft 210 is positioned at an upper end of the shredding portion 200, and is exposed to the opened lower end of the hopper 100.

Therefore, by the rotary shaft 210 that is rotating the disk 220 and the rotary blade 231, the rotary blade 231 may be configured to shred and move the waste fishing net that is introduced.

In addition, the rotary shaft 210 may have a similar size to or have a predetermined size smaller than a length of an opened upper end of a housing that constitutes an outer appearance of the shredding portion 200.

The disk 220 is provided such that a center portion of the disk 220 is connected to the rotary shaft 210, and a plurality of disks 220 may be arranged in a direction perpendicularly to the rotary shaft 210.

In addition, the rotary blade 231 may be connected to a first side portion of an outer circumferential surface of the disk 220.

At this time, the rotary blade 231 is positioned in a direction corresponding to the rotary shaft 210, and the rotary blade 231 may be connected with being in contact with the outer circumferential surfaces of the plurality of disks 220.

FIG. 4 is a partially enlarged view illustrating a configuration of the blade 230 of the waste fishing net shredder 1.

The blade 230 may be arranged at the outer circumferential surface of the disk 220.

Specifically, the blade 230 is provided to cut or shred the waste fishing net that is introduced, and the blade 230 may include the rotary blade 231 and a fixed blade 232.

The rotary blade 231 is protrudingly formed from the outer circumferential surface of the disk 220, and a plurality of the rotary blades 231 that rotate together with the rotary shaft 210 may be provided.

Specifically, the rotary blade 231 is formed in a plate shape that is protruding from the disk 220 in a longitudinal direction and provided to be rotated around the rotary shaft 210 together with the disk 220, and an edge of the rotary blade 231 is configured to intersect periodically with the fixed blade 232 while the rotary blade 231 is being rotated.

Therefore, when the rotary blade 231 intersects with the fixed blade 232, shearing force of the rotary blade 231 and shearing force of the fixed blade 232 act simultaneously, so that the waste fishing net may be easily and efficiently cut or shredded.

In addition, the rotary blade 231 may have a first end connected to the outer circumferential surface of the plurality of disks 220, and may have an edge of a second end provided with a cutting edge that is configured to shred the waste fishing net.

In addition, by the rotary blade 231 being rotated in a state in which the rotary blade 231 is attached to the outer circumferential surface of the disk 220 that is being rotated, the waste fishing net that is introduced is shredded by the cutting edge at a portion that intersects with the fixed blade 232 among a rotational moving line of the rotary blade 231.

Accordingly, since the rotary blade 231 configured to act as the shearing force to the waste fishing net in a similar principle of shearing force of a knife or scissors, so that a waste fishing net formed of a synthetic resin material that is difficult to shred may be easily cut or shredded.

In addition, when the rotary blade 231 rotationally moves from a lower end to an upper end, the rotary blade 231 may perform a guide action that allows the waste fishing net that is not transferred to the collecting portion to be moved upward again.

Therefore, the rotary blade 231 guides the waste fishing net that is not shredded to a predetermined length or a predetermined size, and allows the waste fishing net to be easily rotated, so that the waste fishing net may be repeatedly subjected to the shredding process.

In addition, in order to improve the shearing force acting on the waste fishing net, a center portion of the rotary blade 231 may include a bent portion 231a.

The bent portion 231a may be formed such that the center portion of the rotary blade 231 is bent at a predetermined angle so that both ends of the rotary blade 231 are tilted downward.

Specifically, since the bent portion 231a is formed to bend the rotary blade 231 in the predetermined angle, the rotary blade 231 may be formed in a V-shape by allowing the both ends of the rotary blade 231 to be tilted downward.

Therefore, since the rotary blade 231 is bent in the predetermined angle by the bent portion 231a so as to have the V-shape, the shearing force of the rotary blade 231 acting on the waste fishing net may be concentrated to the waste fishing net by the bent portion 231a, so that there is an effect in that the shearing force acting on the waste fishing net is maximized.

Therefore, the bent portion 231a may preferably be positioned at the center portion of the rotary blade 231.

In addition, it may be preferable that the bent portion 231a is bent at an angle that is capable of maximizing the shearing force of the rotary blade 231 and also capable of allowing a rotation of the rotary blade 231 to be smooth.

In addition, the bent portion 231a allows accommodating of the waste fishing net to be easily realized while the bent portion 231a performs a function of guiding the waste fishing net upward, so that there is an effect that the waste fishing net is efficiently moved.

In addition, the bent portion 231a may be formed in the V-shape as illustrated in drawings, but may have a shape having the same effect as the V-shape. That is, a U-shape that is bent to a predetermined angle, known shapes having a concaved curve, etc., may be applied and implemented without having a limitation.

In order for the fixed blade 232 to be intersected periodically with the rotary blade 231, the fixed blade 232 may be provided at a first side portion that is spaced apart from the rotary shaft 210.

Specifically, the fixed blade 232 is formed in a plate shape extending in a longitudinal direction thereof and is provided at the first side that is spaced apart to be parallel to the rotary shaft 210, and is configured to be fixed without being rotated or being moved.

Therefore, the fixed blade 232 has a configuration in that an edge of the fixed blade 232 adjacent to the rotary shaft 210 may be intersected periodically with the edge of the rotary blade 231.

Accordingly, the waste fishing net is cut or shredded when the fixed blade 232 is intersected with the rotary blade 231, which is a configuration that is capable of maximizing the shearing force acting on the waste fishing net by allowing both the shearing force of the rotary blade 231 and the shearing force of the fixed blade 232 to be combined, so that a large amount of the waste fishing net formed of a synthetic resin material is capable of being shredded in a size appropriate for recycling.

Therefore, a principle of shredding the waste fishing net by the fixed blade 232 intersecting with the rotary blade 231 is a similar principle of a shredding using scissors, so that shredding of a waste fishing net that is difficult to be performed by a conventional shredder may be easily and efficiently realized by a shredding force acting on the waste fishing net.

In addition, a pair of fixed blades 232 may be provided at both corresponding sides. The number of fixed blades 232 is not limited thereto, and various numbers of fixed blades 232 may be applied and implemented depending on a size and a scale of the waste fishing net shredder 1.

The support base 240 is provided at a first side portion adjacent to the blade 230 and extending in a longitudinal direction thereof, and is provided to support the waste fishing net that is introduced.

Specifically, the support base 240 is provided at the first side portion adjacent to the fixed blade 232, and may be formed in a plate shape that has a predetermined width configured to mount or support the waste fishing net that is introduced.

In addition, it may be preferable that a pair of the support bases 240 are provided at both sides of the rotating moving line of the blade 230.

When the process of shredding the waste fishing net of the process (c) is performed by using the waste fishing net shredder 1 aforementioned, there is an effect that a large amount of the waste fishing net formed of a synthetic resin material is capable of being shredded in a size appropriate for recycling since the plurality of rotary blades 231 is included, in which the rotary blade 231 is formed in the V-shape and protrudingly formed from the outer circumferential surface of the plurality of disks 220 that are rotated together with the rotary shaft 210 and is rotated together with both the rotary shaft 210 and the disk 220. In addition, since the rotary blade 231 is formed to have the V-shape by forming the bent portion 231a that allows the both ends of the blade 230 to be tilted downward, the waste fishing net is concentrated inside the bent portion 231a, so that there is an effect that efficiency of the shredding of the waste fishing net is improved. In addition, since the bent portion 231a is configured to improve the shearing force of the blade 230 and the shearing force acts on the waste fishing net that is accommodated inside the bent portion 231a, the waste fishing net formed of a synthetic resin material may be easily and efficiently shredded. In addition, since the fixed blade 232 intersected periodically with the rotary shaft 210 that is rotated and the shearing force of both the fixed blade 232 and the rotary blade 231 act simultaneously on the waste fishing net, there is an effect that the waste fishing net is easily shredded by maximizing the shearing force acting on the waste fishing net.

Next, at the process (d), a process of mixing cement, fine aggregate, and an admixture is performed with a speed of 57 rpm to 67 rpm so that the cement, the fine aggregate, and the admixture are uniformly mixed.

Next, at the process (e), a process of mixing by adding water into the dry mixture in which the cement, the fine aggregate, and the admixture are mixed is performed with a speed of 57 rpm to 67 rpm so that the dry mixture and the water is uniformly stirred.

In the process (f) and the process (g), the fibrous reinforcing material formed of the waste fishing net is added twice (primarily adding and secondarily adding) into the cement mortar obtained from a previous process. In other words, half of a total amount of the used fibrous reinforcing material is added for each of the primarily adding and the secondarily adding, in which the fibrous reinforcing material formed of the waste fishing net used in each adding is not added all at once, but a subdivided amount thereof is added.

More specifically, in the process (f) that corresponds to the primarily adding of the fibrous reinforcing material, 50% of a total amount of the fibrous reinforcing material used to manufacture the cement mortar composition reinforced with the shredded waste fishing net is added and mixed at a speed of 57 rpm to 67 rpm.

Next, in the process (g) that corresponds to the secondarily adding of the fibrous material, remaining 50% of a total amount of the fibrous reinforcing material used to manufacture the cement mortar composition reinforced with the shredded waste fishing net is added and stirred at a speed of 57 rpm to 67 rpm, and mixing at a speed of 115 rpm to 135 rpm is performed so as to allow the added fibrous reinforcing material to be evenly mixed when the adding of the fibrous reinforcing material is completed, thereby obtaining the cement mortar composition reinforced with the shredded waste fishing net.

According to the aforementioned method of manufacturing the cement mortar composition reinforced with the shredded waste fishing net of the present disclosure, the cement mortar composition that has improved crack resistance and tensile strength and in which an environmentally friendly and inexpensive reinforcing material obtained by shredding a waste fishing net at a random length instead of existing highly-expensive reinforcing material is included may be realized.

In particular, according to the cement mortar composition reinforced with the shredded waste fishing net of the present disclosure, by including the fibrous reinforcing material formed of a single yarn obtained by shredding a waste knotless fishing net, there is an advantage in that a problem of lowered reinforcing performance due to a knot and a loosening phenomenon of a reinforcing material may be prevented, in which the reinforcing material using the single yarn provides advantage compared to the reinforcing material using a waste fishing net formed of a plied yarn and including a knot.

In addition, a fiber shredded to have a relatively short length among the fibrous reinforcing material controls cracking of the cement mortar composition, and a fiber shredded to have a relatively long length among the fibrous reinforcing material functions to improve tensile strength and flexural toughness of the cement mortar composition.

What is claimed is:

1. A cement mortar composition reinforced with a shredded waste fishing net, the cement mortar composition comprising:
a cement mortar comprising cement, fine aggregate, and water; and
0.5 to 2.0 parts by weight of a fibrous reinforcing material based on 100 parts by weight of the cement mortar, the fibrous reinforcing material being manufactured by shredding a knotless fishing net and being formed of a single yarn that has a length of 3 mm to 60 mm and a diameter of 0.1 mm to 1 mm.

2. The cement mortar composition of claim 1, wherein the fibrous reinforcing material comprises at least one of polyethylene (PE), polypropylene (PP), polyethylene terephthalate (PET), polyvinyl chloride (PVC), polystyrene (PS), or a polyamide-based (PA) polymer.

3. A method of manufacturing a cement mortar composition reinforced with a shredded waste fishing net, the method comprising:
(a) collecting a waste knotless fishing net and washing off impurities on the waste knotless fishing net;
(b) drying the washed waste knotless fishing net;
(c) manufacturing a fibrous reinforcing material formed of a single yarn having a length of 3 mm to 60 mm and a diameter of 0.1 mm to 1 mm by shredding the dried waste knotless fishing net;
(d) dry-mixing cement, fine aggregate, and an admixture;
(e) mixing by adding water into a dry mixture that is obtained from the dry-mixing (d);
(f) mixing by adding the fibrous reinforcing material into a cement mortar that is obtained from the mixing (e); and
(g) manufacturing a cement mortar composition by further adding the fibrous reinforcing material into the cement mortar that is obtained from the mixing (f) and includes the fibrous reinforcing material so that the cement mortar composition including 0.5 to 2.0 parts by weight of the fibrous reinforcing material based on 100 parts by weight of the cement mortar is manufactured.

4. The method of claim 3, wherein the cement, the fine aggregate, the admixture are mixed at a speed of 57 rpm to 67 rpm at the process (d).

5. The method of claim 3, wherein water is added into the dry mixture obtained at the process (d), and water and the dry mixture are mixed at a speed of 57 rpm to 67 rpm.

6. The method of claim 3, wherein, at the process (f), 50% of a total amount of the fibrous reinforcing material used to manufacture the cement mortar composition reinforced with the shredded waste fishing net is added and mixed at a speed of 57 rpm to 67 rpm.

7. The method of claim 3, wherein, at the process (g), remaining 50% of a total amount of the fibrous reinforcing material used to manufacture the cement mortar composition reinforced with the shredded waste fishing net is added and stirred at a speed of 57 rpm to 67 rpm, and mixing at a speed of 115 rpm to 135 rpm is performed so as to allow the added fibrous reinforcing material to be evenly mixed when adding of the fibrous reinforcing material is completed, thereby manufacturing the cement mortar composition reinforced with the shredded waste fishing net.
